(19) United States
(12) Patent Application Publication
(10) Pub. No.: US 2015/0312444 A1
(43) Pub. Date: Oct. 29, 2015

(54) METHOD AND DEVICE FOR SYNCHRONIZING PHOTOGRAPH

(71) Applicant: Xiaomi Inc., Beijing (CN)

(72) Inventors: Jingwei Cai, Beijing (CN); Tao Guo, Beijing (CN); Hai Jiang, Beijing (CN)

(21) Appl. No.: 14/529,174

(22) Filed: Oct. 31, 2014

Related U.S. Application Data
(63) Continuation of application No. PCT/CN2014/084352, filed on Aug. 14, 2014.

(30) Foreign Application Priority Data
Apr. 29, 2014 (CN) 201410177513.X

(51) Int. Cl. H04N 5/04

(52) U.S. Cl. CPC H04N 5/04

(57) ABSTRACT

The present disclosure relates to a method, a server and a terminal device for synchronizing a photograph. The method includes: sending an instruction for synchronizing a re-focusable photograph to a second terminal device; receiving a notification returned from the second terminal device with regard to whether the second terminal device supports a display of re-focusable photographs; sending data for downloading a re-focusable photograph group to the second terminal device, if the second terminal device supports the display of the re-focusable photographs; and sending an index photograph of the re-focusable photograph group to the second terminal device, if the second terminal device does not support the display of the re-focusable photographs. Through the solutions according to the present disclosure, network resources occupied by the synchronizing may be saved.

### CROSS-REFERENCE TO RELATED APPLICATIONS

This application is a Continuation of International Application No. PCT/CN2014/084352, filed on Aug. 14, 2014, which is based upon and claims the benefit of priority to Chinese Patent Application No. CN 201410177513.X, filed on Apr. 29, 2014, the entire contents of which are incorporated herein by reference.

### TECHNICAL FIELD

The present disclosure generally relates to the field of terminal technology, and more particularly, to a method, a server and a terminal device for synchronizing a photograph.

### BACKGROUND

UbiFocus is a technology, which supports terminal devices to photograph first and focus afterwards, so as to facilitate re-focusing of a photograph after it has been captured. Such technology allows a user to take a photograph first and focus the photograph afterwards, by which the user can arbitrarily select a focus point in the photograph captured, to achieve different effects of field depth.

Ubifocus photographing improves the users experience. Accordingly, it has become an urgent need of users to upload an Ubifocus photograph to a cloud and synchronize it among a plurality of terminal devices. Using the implementation of the present disclosure, not only burden on a local storage may be lessened, but also photograph data of users may be more secured, and moreover, a user is allowed to similarly perform Ubifocus refocusing on a terminal device that does not support Ubifocus photographing.

In the related art, in a case where a group of Ubifocus photographs is displayed in a cloud, one of the Ubifocus photographs is typically displayed as an index in a default manner. When the Ubifocus index photograph needs to be replaced by the user, the modified Ubifocus index photograph has to be re-uploaded to the cloud.

### SUMMARY

Accordingly, a method, a server and a terminal device for synchronizing a photograph are provided by the present disclosure.

According to a first aspect of embodiments of the present disclosure, there provides a method for synchronizing a photograph in a server, including: sending an instruction for synchronizing a re-focusable photograph to a second terminal device; receiving a notification returned from the second terminal device with regard to whether the second terminal device supports a display of re-focusable photographs; sending data for downloading a re-focusable photograph group to the second terminal device, if the second terminal device supports the display of the re-focusable photographs; and sending an index photograph of the re-focusable photograph group to the second terminal device, if the second terminal device does not support the display of the re-focusable photographs.

According to a second aspect of embodiments of the present disclosure, there provides a method for synchronizing a photograph in a terminal device, including: receiving an instruction for synchronizing a re-focusable photograph sent from a server; returning a notification with regard to whether the terminal device supports a display of re-focusable photographs; receiving data for downloading the re-focusable photograph group sent from the server, if the terminal device supports the display of the re-focusable photographs; and receiving an index photograph of the re-focusable photograph group sent from the server, if the terminal device does not support the display of the re-focusable photographs.

According to a third aspect of embodiments of the present disclosure, there provides a server synchronizing a photograph in a terminal device, including: a processor; and a memory for storing instructions executable by the processor, wherein the processor is configured to perform: sending an instruction for synchronizing a re-focusable photograph to a second terminal device; receiving a notification returned from the second terminal device with regard to whether the second terminal device supports a display of re-focusable photographs; sending data for downloading a re-focusable photograph group to the second terminal device, if the second terminal device supports the display of the re-focusable photographs; and sending an index photograph of the re-focusable photograph group to the second terminal device, if the second terminal device does not support the display of the re-focusable photographs.

According to a fourth aspect of embodiments of the present disclosure, there provides a terminal device for synchronizing a photograph in a server, including: a processor; and a memory for storing instructions executable by the processor, wherein the processor is configured to perform: receiving an instruction for synchronizing a re-focusable photograph sent from a server; returning a notification with regard to whether the terminal device supports a display of re-focusable photographs; receiving data for downloading the re-focusable photograph group sent from the server, if the terminal device supports the display of the re-focusable photographs; and receiving an index photograph of the re-focusable photograph group sent from the server, if the terminal device does not support the display of the re-focusable photographs.

Therefore, in the present disclosure, during the time a terminal device uploads a re-focusable photograph group to be synchronized to a binding server in a cloud, the server assigns an ID to the re-focusable photograph group, and the terminal device assigns an intra-group number to each photograph in the re-focusable photograph group. After an index photograph is determined, an intra-group number corresponding to the index photograph is informed to the server. Since the server learns about each intra-group number of each of the photograph in the re-focusable photograph group, in case where the index photograph of the re-focusable photograph group uploaded by the terminal device needs to be replaced subsequently, the index photograph to be replaced does not need to be re-uploaded, but only the intra-group number corresponding to the replacement index photograph and the corresponding ID need to be uploaded, thereby, network resources occupied by synchronizing the photograph may be saved.

It should be understood that both the foregoing general description and the following detailed description are exemplary and explanatory only and do not intend to limit the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flow chart showing a method for synchronizing a photograph on a first terminal device side according to an embodiment of the present disclosure;

FIG. 2 is a flow chart showing another method for synchronizing a photograph based on the embodiment shown in FIG. 1;

FIG. 3 is a flow chart showing a method for synchronizing a photograph on a server side according to an embodiment of the present disclosure;

FIG. 4 is a flow chart showing another method for synchronizing a photograph based on the embodiment shown in FIG. 4;

FIG. 5 is a flow chart showing another method for synchronizing a photograph on a server side according to an embodiment of the present disclosure;

FIG. 6 is a detailed flow chart showing step S503 in FIG. 5;

FIG. 7 is a flow chart showing still another method for synchronizing a photograph on a server side according to an embodiment of the present disclosure;

FIG. 8 is a flow chart showing a method for synchronizing a photograph on a second terminal device side according to an embodiment of the present disclosure;

FIG. 9 is a detailed flow chart showing step S803 in FIG. 5;

FIG. 10 is a flow chart showing another method for synchronizing a photograph on a second terminal device side according to an embodiment of the present disclosure;

FIG. 11 is a block diagram showing an apparatus in a first terminal device according to an embodiment of the present disclosure;

FIG. 12 is a block diagram showing another apparatus in a first terminal device according to an embodiment of the present disclosure;

FIG. 13 is a block diagram showing an apparatus in a server according to an embodiment of the present disclosure;

FIG. 14 is a block diagram showing another apparatus in a server according to an embodiment of the present disclosure;

FIG. 15 is a block diagram showing still another apparatus in a server according to an embodiment of the present disclosure;

FIG. 16 is a block diagram showing a first sending module 153 in FIG. 15;

FIG. 17 is a block diagram showing still another apparatus in a server according to an embodiment of the present disclosure;

FIG. 18 is a block diagram showing an apparatus in a second terminal device according to an embodiment of the present disclosure;

FIG. 19 is a block diagram showing a first data receiving module 183 in FIG. 18;

FIG. 20 is a block diagram showing another apparatus in a second terminal device according to an embodiment of the present disclosure;

FIG. 21 is a block diagram showing a terminal device according to an embodiment of the present disclosure; and

FIG. 22 is a block diagram showing a server according to an embodiment of the present disclosure.

Through the above accompany drawings, the specific embodiments of the disclosure have been illustrated, and a more detailed description may be given as below. These drawings and the textual description are not intended to limit the scope of the concept of the disclosure in any manner, but to explain the concept of the disclosure to those skilled in the art with reference to particular embodiments.

### DETAILED DESCRIPTION

In the following, a detailed description may be given to exemplary embodiments, examples of which are illustrated in the accompany drawings. Where an accompany drawing is referred in the following description, the same number indicates same or similar elements in different accompany drawings, unless specified otherwise. The embodiments described in the following exemplary embodiments do not represent all of the embodiments in consistent with the present disclosure. On the contrary, they are only examples of apparatuses, terminal devices, servers and methods in consistent with some aspects of the present disclosure, as set forth in the appended claims.

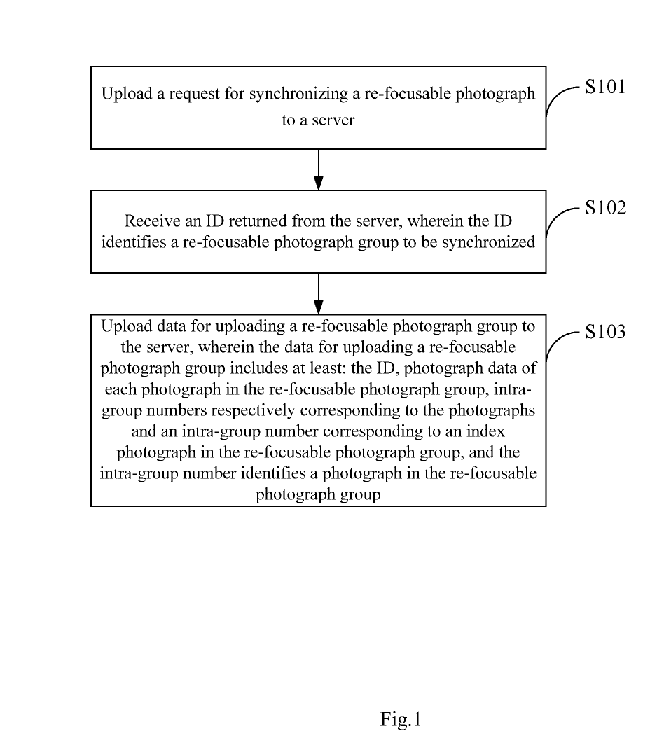

FIG. 1 is a flow chart showing a method for synchronizing a photograph on a first terminal device side according to an embodiment of the present disclosure. As shown in FIG. 1, the method for synchronizing a photograph is performed by the first terminal device, and may include the following steps.

In step S101, a request for synchronizing a re-focusable photograph is uploaded to a server.

In step S102, an ID returned from the server is received, wherein the ID identifies a re-focusable photograph group to be synchronized.

In steps S103, data for uploading the re-focusable photograph group is uploaded to the server, wherein the data for uploading a re-focusable photograph group at least includes: the ID, photograph data of each photograph in the re-focusable photograph group, intra-group numbers respectively corresponding to the photographs and an intra-group number corresponding to an index photograph in the re-focusable photograph group, and the intra-group number identifies a photograph in the re-focusable photograph group.

In this embodiment, photograph synchronizing is performed between the terminal device and the binding server in a cloud, and the photographs to be synchronized are re-focusable photographs, such as Ubifocus photographs.

In step S101, firstly, a first terminal device uploads the request for synchronizing the re-focusable photograph to the server, informing the server it will upload the re-focusable photograph to be synchronized to the server.

Typically, the re-focusable photograph to be synchronized is uploaded to the server in the cloud by the terminal device, and then, the server synchronizes the received re-focusable photograph to be synchronized among other binding terminal devices. In the present disclosure, in order to distinguish the terminal devices, the terminal device that uploads a re-focusable photograph to be synchronized to the server in the cloud is referred to as “first terminal device”, and another terminal device with which the server synchronizes the photograph is referred to as “second terminal device”.

In step S102, the first terminal device receives the ID returned from the server, and the server identifies the received re-focusable photograph group through the ID. That is due to the fact that, when uploading re-focusable photographs, the first terminal device will typically upload a group of photographs of the same scene but with different focus distances, that is, the re-focusable photograph group. In order to distinguish the different re-focusable photograph groups uploaded by the first terminal device, the server assigns an ID to each re-focusable photograph group uploaded by the first terminal device, so different re-focusable photograph groups have a different ID, and every photograph in the same re-focusable photograph group have the same ID, i.e., the ID corresponding to the re-focusable photograph group that the photographs belong to. After assigning the ID, the sever returns the ID to the first terminal device.

In step S103, after the first terminal device receives the ID returned from the server, the first terminal device starts to upload the data for uploading the re-focusable photograph group to the server, wherein the data for uploading the re-focusable photograph group includes at least: the ID, the photograph data of each of the photographs in the re-focusable photograph group, the intra-group numbers respectively corresponding to the photographs and the intra-group number corresponding to an index photograph in the re-focusable photograph group. Wherein, each of the photographs in the re-focusable photograph group is assigned with the ID. In addition, the first terminal device assigns an intra-group number for each photograph in the re-focusable photograph group, wherein different photograph has a different intra-group number. Each photograph in the re-focusable photograph group is identified through the intra-group number. Thereby, after an index photograph corresponding to a re-focusable photograph group is determined, only the intra-group number corresponding to the index photograph needs to be informed to the server.

In the present disclosure, during the time the terminal device uploads the re-focusable photograph group to be synchronized to the binding server in the cloud, the servers assigns the ID to the re-focusable photograph group, and the terminal device assigns the intra-group number to each photograph in the re-focusable photograph group. After the index photograph is determined, the intra-group number corresponding to the index photograph is informed to the server. Since the server learns about each intra-group number of each of the photograph in the re-focusable photograph group, in case where the index photograph of the re-focusable photograph group uploaded by the terminal device needs to be replaced subsequently, a replacement index photograph does not need to be re-uploaded, but only the intra-group number corresponding to the replacement index photograph and the corresponding ID need to be uploaded, thereby, network resources occupied by synchronizing the photograph may be saved.

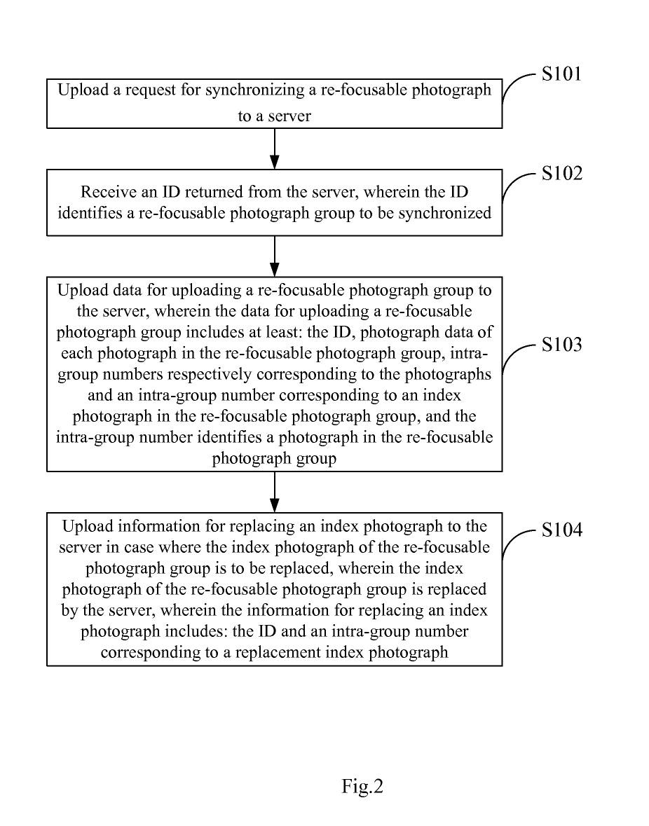

In the following, a process of replacing an index photograph in a re-focusable photograph group is described through an embodiment shown in FIG. 2, and the process may include the following steps.

In step S101, a request for synchronizing a re-focusable photograph is uploaded to a server.

In step S102, an ID returned from the server is received, wherein the ID identifies a re-focusable photograph group to be synchronized.

In steps S103, data for uploading the re-focusable photograph group is uploaded to the server, wherein the data for uploading the re-focusable photograph group includes at least the ID, photograph data of each of the photographs in the re-focusable photograph group, intra-group numbers respectively corresponding to the photographs and an intra-group number corresponding to an index photograph in the re-focusable photograph group, and the intra-group number identifies each photograph in the re-focusable photograph group.

In step S104, in case where the index photograph of the re-focusable photograph group is to be replaced, information for replacing an index photograph is uploaded to the server, and the index photograph of the re-focusable photograph group is replaced by the server, wherein the information for replacing the index photograph includes the ID and an intra-group number corresponding to a replacement index photograph.

In this embodiment, since the server learns about each intra-group number of each of the photographs in the re-focusable photograph group, in case where the index photograph of the re-focusable photograph group uploaded by the first terminal device needs to be replaced subsequently, the replacement index photograph does not need to be re-uploaded, but only the information for replacing the index photograph needs to be uploaded, in which the intra-group number corresponding to the replacement index photograph and the corresponding ID is carried, and then the index photograph of the re-focusable photograph group is replaced by the server. Accordingly, the replacement index photograph does not need to be re-uploaded by the first terminal device, but only the intra-group number corresponding to the replacement index photograph and the corresponding ID need to be uploaded, thereby, network resources occupied by synchronizing the photograph may be saved.

For the server, since it learns about each intra-group number of each of the photographs in the re-focusable photograph group, upon receiving the intra-group number corresponding to the replacement index photograph and the corresponding ID uploaded by the first terminal device, the server may determine the replacement index photograph according to the intra-group number, and replace the index photograph.

In the following, the process of synchronizing a photograph is described with a specific application scenario.

Taking synchronizing an Ubifocus photograph for example, when the first terminal device uploads the group of Ubifocus photographs to the server, each photograph in the Ubifocus photograph group is assigned with the intra-group number and the ID corresponding to the group to which it belongs. In a default manner, for the currently uploaded Ubifocus photograph group, the index photograph displayed is a photograph with an intra-group number 1. When the user needs to change the index photograph to a photograph with an intra-group number 3, the user may send the synchronizing instruction to the server in the cloud, wherein the instruction includes at least the ID of the Ubifocus photograph group to be changed, and the intra-group number 3 corresponding to the replacement index photograph. After receiving the synchronizing instruction, the server in the cloud searches out the corresponding Ubifocus photograph group according to the ID, and sets the photograph with the intra-group number 3 as the index photograph. Accordingly, the photograph with the intra-group number 3 does not need to be re-uploaded, thereby, network resources occupied by synchronizing the photograph may be saved, and synchronization may be achieved in seconds.

In the methods according to the above embodiments, the implementation process of synchronizing a photograph is described from the first terminal device side. In the following, an implementation process of synchronizing a photograph may be described from the server side.

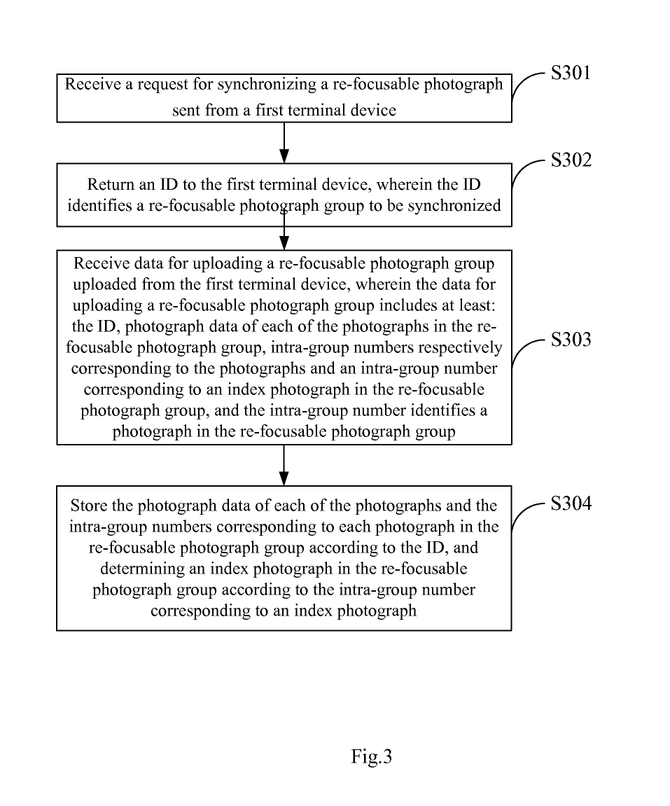

As shown in FIG. 3, which is a flow chart showing a process of synchronizing a photograph on the server side, and the process may include the following steps.

In step S301, a request for synchronizing a re-focusable photograph sent from a first terminal device is received.

In step S302, an ID is returned to the first terminal device, wherein the ID identifies a re-focusable photograph group to be synchronized.

In step S303, data for uploading the re-focusable photograph group uploaded from the first terminal device is received, wherein the data for uploading a re-focusable photograph group includes at least the ID, photograph data of each of the photographs in the re-focusable photograph group, intra-group numbers respectively corresponding to the photographs and an intra-group number corresponding to an index photograph in the re-focusable photograph group, and the intra-group number identifies a photograph in the re-focusable photograph group.

In step S304, photograph data of each photograph and intra-group numbers corresponding to each photograph in the re-focusable photograph group are stored according to the ID, and an index photograph in the re-focusable photograph group is determined according to the intra-group number corresponding to an index photograph.

In this embodiment, for uploading re-focusable photographs, the first terminal device will typically upload a group of photographs of the same scene but with different focus distances, that is, the re-focusable photograph group. In order to distinguish the different re-focusable photograph groups uploaded by the first terminal device, the server assigns the ID to each re-focusable photograph group uploaded by the first terminal device, so different re-focusable photograph groups have a different ID, and every photograph in the same re-focusable photograph group have the same ID. After assigning the ID, the sever returns the ID to the first terminal device.

After the first terminal device receives the ID returned from the server, the first terminal device starts to upload data for uploading the re-focusable photograph group to the server, wherein the data for uploading the re-focusable photograph group includes at least the ID, the photograph data of each of the photographs in the re-focusable photograph group, the intra-group numbers respectively corresponding to the photographs and the intra-group number corresponding to an index photograph in the re-focusable photograph group. Wherein, each photograph in the re-focusable photograph group is assigned with the ID. In addition, the first terminal device assigns the intra-group number for each photograph in the re-focusable photograph group, wherein different photograph has a different intra-group number. Each photograph in the re-focusable photograph group is identified through the intra-group number. Thereby, after an index photograph corresponding to a re-focusable photograph group is determined, only the intra-group number corresponding to the index photograph needs to be informed to the server.

In the present disclosure, during the time when a terminal device uploads the re-focusable photograph group to be synchronized to a binding server in a cloud, the servers assigns the ID to the re-focusable photograph group, and the terminal device assigns the intra-group number to each photograph in the re-focusable photograph group. After the index photograph is determined, the intra-group number corresponding to the index photograph is informed to the server. Since the server learns about each intra-group number of each of the photograph in the re-focusable photograph group, in case where the index photograph of the re-focusable photograph group uploaded by the terminal device needs to be replaced subsequently, a replacement index photograph does not need to be re-uploaded, but only the intra-group number corresponding to the replacement index photograph and the corresponding ID need to be uploaded, thereby, network resources occupied by synchronizing the photograph may be saved.

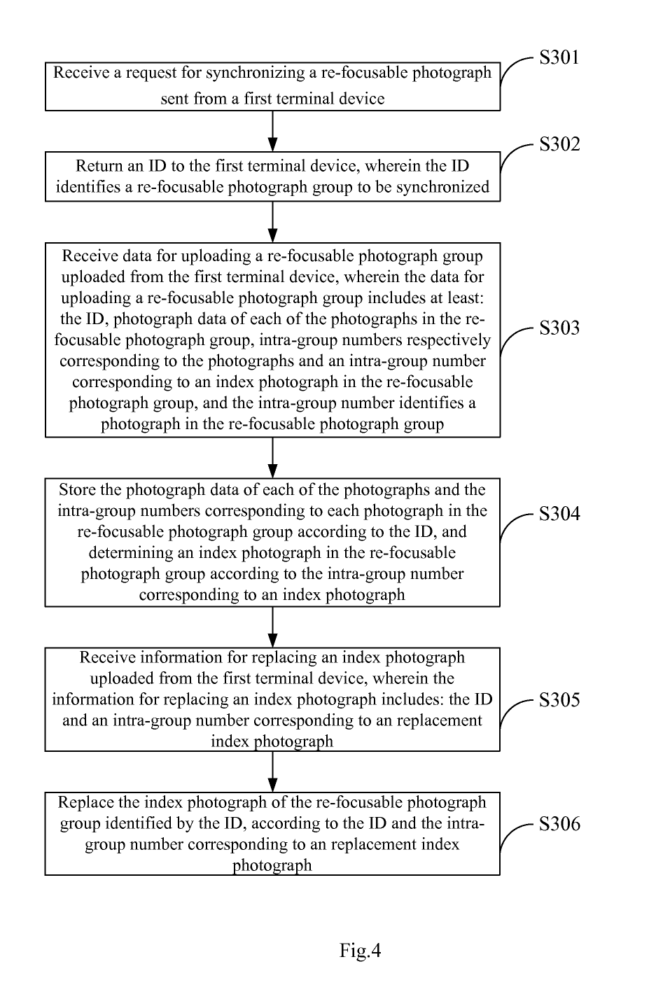

FIG. 4 shows a process of replacing an index photograph of a re-focusable photograph group on a server side according to an embodiment. Based on the embodiment shown in FIG. 3, the process may further include the following steps.

In step S305, information for replacing an index photograph uploaded from a first terminal device is received, wherein the information for replacing the index photograph includes the ID and an intra-group number corresponding to a replacement index photograph.

In step S306, the index photograph of a re-focusable photograph group identified by the ID is replaced, according to the ID and the intra-group number corresponding to the replacement index photograph.

In this embodiment, since the server learns about each intra-group number of each of the photographs in the re-focusable photograph group, in case where the index photograph of the re-focusable photograph group uploaded by the first terminal device needs to be replaced subsequently, the replacement index photograph does not need to be re-uploaded, but only the information for replacing an index photograph needs to be uploaded, in which the intra-group number corresponding to the replacement index photograph and the corresponding ID is carried, and then the index photograph of the re-focusable photograph group is replaced by the server. Since the replacement index photograph does not need to be re-uploaded by the first terminal device, but only the intra-group number corresponding to the replacement index photograph and the corresponding ID need to be uploaded, network resources occupied by synchronizing the photograph may be saved. Since the server learns about each intra-group number of each of the photographs in the re-focusable photograph group, upon receiving the intra-group number corresponding to the replacement index photograph and the corresponding ID uploaded by the first terminal device, the server may determine the replacement index photograph according to the intra-group number, and replace the index photograph.

In the present disclosure, after the server receives a re-focusable photograph group uploaded by the first terminal device, the re-focusable photograph group may be synchronized to a binding second terminal device. In the following, a synchronization process is described in detail.

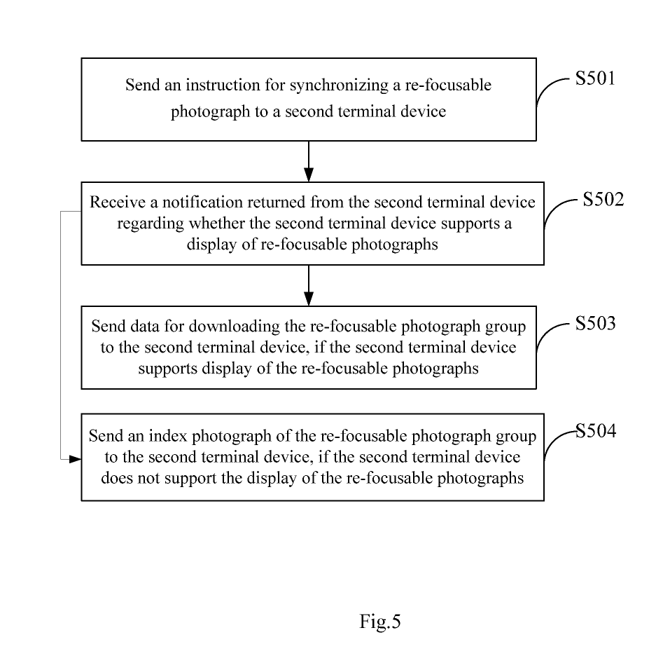

FIG. 5 shows a process of synchronizing a photograph to a second terminal device according to an embodiment, and the process may include the following steps.

In step S501, an instruction for synchronizing a re-focusable photograph is sent to a second terminal device.

In step S502, a notification returned from the second terminal device regarding whether the second terminal device supports a display of re-focusable photographs is received.

In step S503, if the second terminal device supports the display of the re-focusable photographs, data for downloading the re-focusable photograph group is sent to the second terminal device. In other words, data for downloading the re-focusable photograph group is allocated and then sent to the second terminal device.

In step S504, if the second terminal device does not support the display of the re-focusable photographs, an index photograph of the re-focusable photograph group is sent to the second terminal device.

In practical application, implementations for synchronizing the photograph to the second terminal device by the server may be different depending on whether the second terminal device supports the display of the re-focusable photographs or not. Thus, the server needs to firstly confirm whether the second terminal device supports the display of the re-focusable photographs. In this regard, the server needs to send an instruction for synchronizing the re-focusable photograph to the second terminal device, to inform the second terminal device that synchronizing the re-focusable photograph is about to be started. The second terminal device returns the notification regarding whether it supports the display of the re-focusable photographs to the server. The contents of the notification includes: supporting the display of the re-focusable photographs or not supporting the display of the re-focusable photographs. After the server receives the notification returned from the second terminal device, if the second terminal device supports the display of the re-focusable photographs, the server sends data for downloading the re-focusable photograph group to the second terminal device, and if the second terminal device does not support the display of the re-focusable photographs, the server directly sends the index photograph of the re-focusable photograph group to the second terminal device.

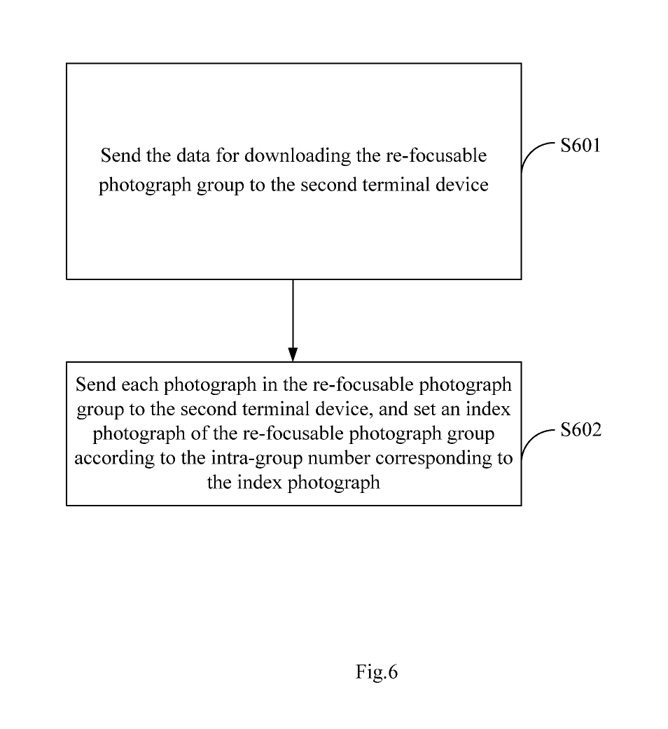

In an embodiment shown in FIG. 6, in case where the second terminal device supports a display of re-focusable photographs, a detailed process of sending data for downloading a re-focusable photograph group to the second terminal device by the server may include the following steps.

In step S601, the data for downloading the re-focusable photograph group is sent to the second terminal device, wherein the data for downloading the re-focusable photograph group include at least: an ID identifying the re-focusable photograph group to be sent, path information corresponding to storage path information of each photograph in the re-focusable photograph group, intra-group numbers indentifying each photograph respectively corresponding to the photographs in the re-focusable photograph group and an intra-group number identifying each photograph in the re-focusable photograph group corresponding to the index photograph in the re-focusable photograph group.

In step S602, each photograph in the re-focusable photograph group is sent to the second terminal device. Moreover the index photograph of the re-focusable photograph group is set according to the intra-group number corresponding to the index photograph.

In this embodiment, the data for downloading the re-focusable photograph group sent by the server may carry the ID of the re-focusable photograph group to be sent, the intra-group numbers and the ID assigned respectively to each photograph in the re-focusable photograph group, the intra-group number corresponding to the index photograph in the re-focusable photograph group and the path information of each photograph in the re-focusable photograph group, wherein the path information respectively correspond to storage path information of each photograph in the re-focusable photograph group, and the intra-group number identifies a photograph in the re-focusable photograph group. While the server sends each photograph in the re-focusable photograph group to the second terminal device, the server sets the index photograph of the re-focusable photograph group according to the intra-group number corresponding to the index photograph.

It should be noted that, the index photograph of the re-focusable photograph group may be sent firstly to the second terminal device, according to the intra-group number corresponding to the index photograph of the re-focusable photograph group.

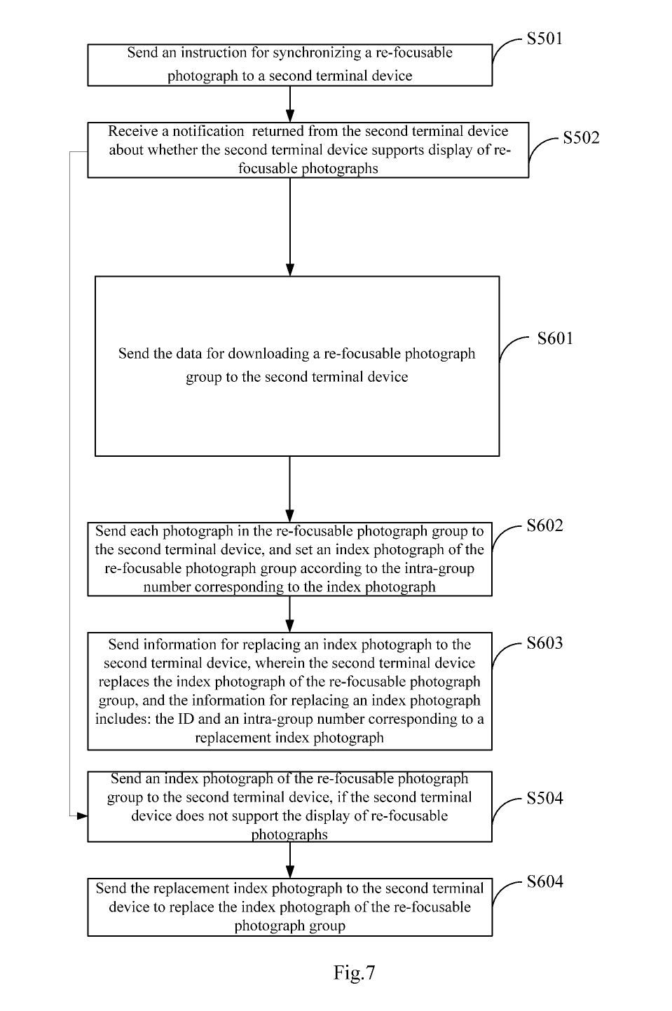

In case where the index photograph of the re-focusable photograph group needs to be replaced, based on the process shown in FIG. 6, the process as shown in FIG. 7 may further include the following steps.

In step S603, if a second terminal device supports a display of re-focusable photographs, information for replacing an index photograph is sent to the second terminal device, and the second terminal device replaces an index photograph of the re-focusable photograph group, wherein the information for replacing an index photograph includes an ID and an intra-group number corresponding to a replacement index photograph.

In step S604, if the second terminal device does not support the display of the re-focusable photographs, the replacement index photograph is sent to the second terminal device to replace the index photograph of the re-focusable photograph group.

Accordingly, if the second terminal device supports the display of the re-focusable photographs, the server may issue the intra-group number and the ID corresponding to the replacement index photograph such that the second terminal device may replace the index photograph of the re-focusable photograph group accordingly. If the second terminal device does not support the display of the re-focusable photographs, the replacement index photograph needs to be directly sent to the second terminal device to replace the index photograph of the re-focusable photograph group.

For the same reason, during the time the server synchronizes a photograph downward, in case where the first terminal device replaces the index photograph of the re-focusable photograph group that has been uploaded, the replacement index photograph does not need to be re-sent to the second terminal device that supports the display of the re-focusable photographs, but only the intra-group number and the ID corresponding to the replacement index photograph of the re-focusable photograph group need to be sent, thereby, network resources occupied by synchronizing the photograph may be saved.

It should be noted that, in this embodiments, the index photograph that the server sends to the second terminal device may be a thumbnail corresponding to the photograph or its photograph data. In addition, each photograph in the re-focusable photograph group that the server sends to the second terminal device may be a thumbnail corresponding to the photograph respectively or its photograph data.

In practical application, data amount of thumbnails are typically smaller than that of original photographs. In case where the thumbnail is synchronized, the demand of the user for generally exploring may be satisfied, and in the meantime the network traffic may be saved. In this case, only when the user clicks the thumbnail, the original photograph data may be downloaded from the server in the cloud. However, if network traffic is not a concern, the original photograph data may be directly synchronized.

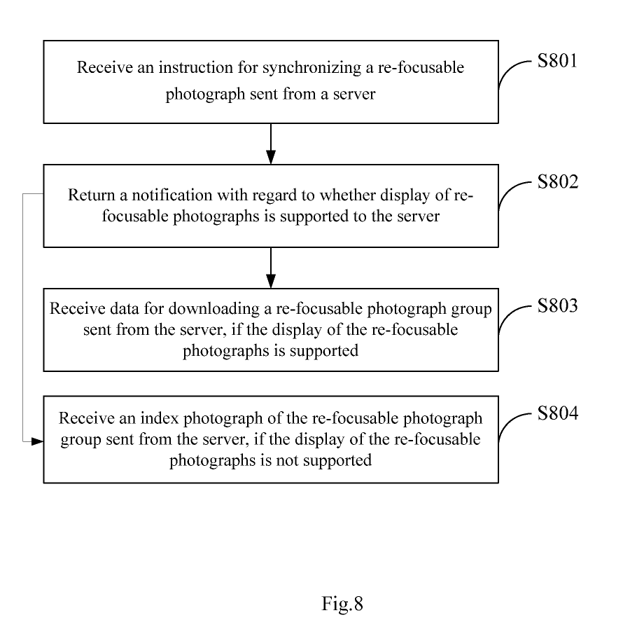

In the above embodiments, a process of synchronizing a photograph is described from a server side. As shown in FIG. 8, the process of synchronizing a photograph is also described on a second terminal device side. The implementation process may include the following steps.

In step S801, an instruction for synchronizing a re-focusable photograph sent from a server is received.

In step S802, a notification with regard to whether a display of re-focusable photographs is supported is returned to the server.

In step S803, if the display of the re-focusable photographs is supported, data for downloading the re-focusable photograph group sent from the server is received.

In step S804, if the display of the re-focusable photographs is not supported, an index photograph of the re-focusable photograph group sent from the server is received.

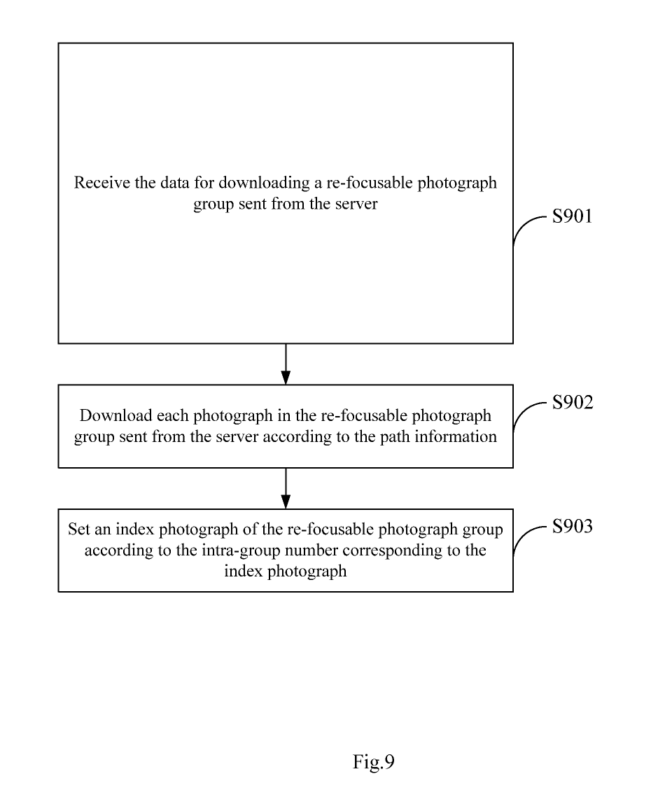

For a second terminal device that supports a display of re-focusable photographs, as shown in FIG. 9, implementation of step S803 may include the following steps.

In step S901, data for downloading a re-focusable photograph group sent from a server is received, wherein the data for downloading the re-focusable photograph group include at least: an ID identifying the re-focusable photograph group to be sent, path information corresponding to storage path information of each photograph in the re-focusable photograph group, intra-group numbers indentifying each photograph respectively corresponding to the photographs in the re-focusable photograph group and an intra-group number identifying each photograph in the re-focusable photograph group corresponding to the index photograph in the re-focusable photograph group.

In step S902, each photograph in the re-focusable photograph group sent from the server are downloaded according to the path information.

In step S903, an index photograph of the re-focusable photograph group is set according to the intra-group number corresponding to the index photograph.

In this embodiment, during the time the server synchronizes a photograph downward, in case where the first terminal device replaces the index photograph of the re-focusable photograph group that has been uploaded, not an replacement index photograph sent by the server, but the above-mentioned data for downloading the re-focusable photograph group sent from the server is received by the second terminal device. This may equally save network resources occupied by synchronizing the photograph.

In the present disclosure, the index photograph of the re-focusable photograph group may be downloaded firstly by the second terminal device, according to the intra-group number corresponding to the index photograph of the re-focusable photograph group.

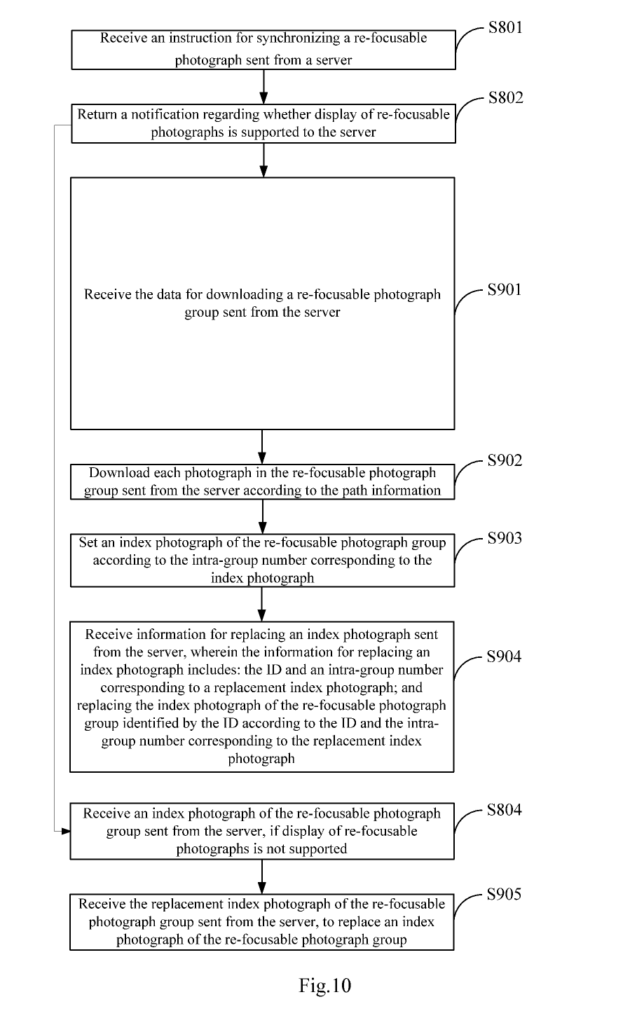

In case where an index photograph of a re-focusable photograph group needs to be replaced, based on the process shown in FIG. 9, a process as shown in FIG. 10 may further include the following steps.

In step 904, if a display of re-focusable photographs is supported, information for replacing an index photograph sent from the server is received, wherein the information for replacing the index photograph includes an ID and an intra-group number corresponding to a replacement index photograph; and the index photograph of the re-focusable photograph group identified by the ID is replaced according to the ID and the intra-group number corresponding to the replacement index photograph.

In step S905, if the display of the re-focusable photographs is not supported, the replacement index photograph sent from the server is received, to replace an index photograph of the re-focusable photograph group.

It should be noted that, in this embodiments, an index photograph that the second terminal device receives may be a thumbnail corresponding to the photograph or its photograph data. In addition, each photograph in the re-focusable photograph group that the second terminal device receives may be a thumbnail corresponding to the photograph respectively or its photograph data.

In practical application, data amount of thumbnails are typically smaller than that of original photographs. In case where the thumbnail is synchronized, the demand of the user for generally exploring may be satisfied, and at the meantime the network traffic may be saved. In this case, only when the user clicks the thumbnail, the original photograph data may be downloaded from the server in the cloud. However, if network traffic is not a concern, the original photograph data may be directly synchronized.

Corresponding to the methods according to the above embodiments, a terminal device and server for synchronizing a photograph according to an embodiment is provided by the present disclosure.

FIG. 11 is a block diagram showing an apparatus in a first terminal device. Referring to FIG. 11, the apparatus in the first terminal device may include: a module for uploading a request for synchronizing a re-focusable photograph 111, configured to upload a request for synchronizing a re-focusable photograph to a server; an ID receiving module 112, configured to receive an ID returned from the server, wherein the ID identifies the re-focusable photograph group to be synchronized; and a photograph uploading module 113, configured to upload data for uploading the re-focusable photograph group to the server, wherein the data for uploading a re-focusable photograph group at least includes: the ID, photograph data of each photograph in the re-focusable photograph group, intra-group numbers respectively corresponding to the photographs and an intra-group number corresponding to an index photograph in the re-focusable photograph group, and the intra-group number identifies a photograph in the re-focusable photograph group.

In the present disclosure, during the time a terminal device uploads the re-focusable photograph group to be synchronized to a binding server in a cloud, the servers assigns the ID to the re-focusable photograph group, and the terminal device assigns the intra-group number to each photograph in the re-focusable photograph group. After the index photograph is determined, the intra-group number corresponding to the index photograph is informed to the server. Since the server learns about each intra-group number of each of the photograph in the re-focusable photograph group, in case where the index photograph of the re-focusable photograph group uploaded by the terminal device needs to be replaced subsequently, a replacement index photograph does not need to be re-uploaded, but only the intra-group number corresponding to the replacement index photograph and the corresponding ID need to be uploaded, thereby, network resources occupied by synchronizing the photograph may be saved.

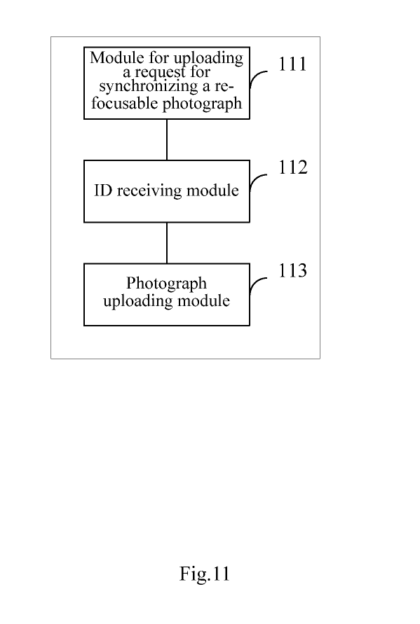

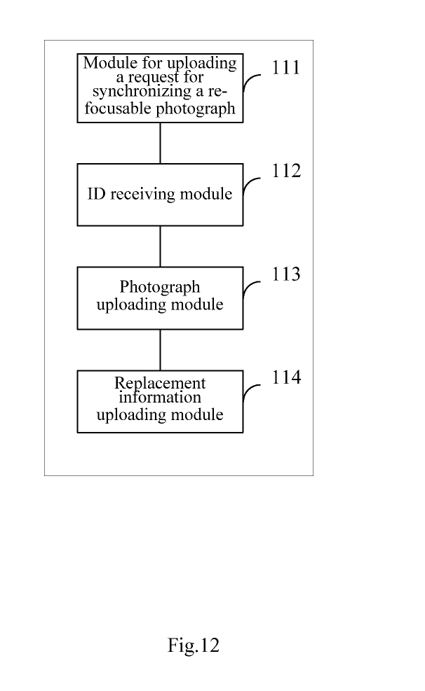

FIG. 12 shows another apparatus in a first terminal device according to another embodiment, and the apparatus may further include: a replacement information uploading module 114, configured to upload information for replacing an index photograph to the server in case where the index photograph of a re-focusable photograph group is to be replaced, wherein the index photograph of the re-focusable photograph group is replaced by the server, wherein the information for replacing an index photograph include: an ID and an intra-group number corresponding to an replacement index photograph.

In this embodiment, since the server learns about each intra-group number of each of the photographs in the re-focusable photograph group, in case where the index photograph of the re-focusable photograph group uploaded by the first terminal device needs to be replaced subsequently, the replacement index photograph does not need to be re-uploaded, but only the intra-group number corresponding to the replacement index photograph and the corresponding ID need to be uploaded, thereby, network resources occupied by synchronizing the photograph may be saved.

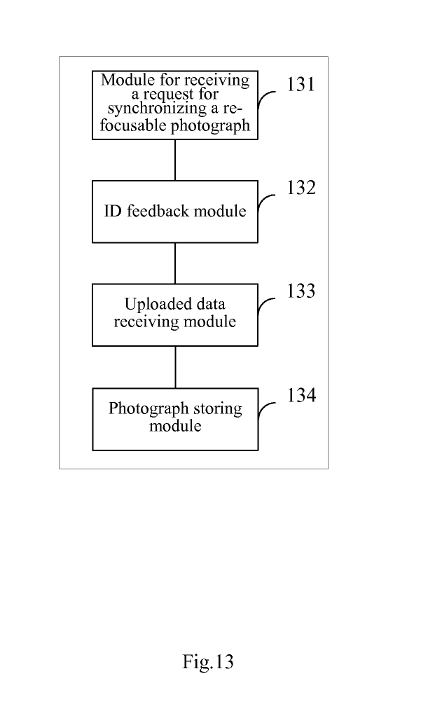

Corresponding to the first terminal device according to above embodiments, FIG. 13 is a block diagram showing an apparatus in a server, and the apparatus may include: a module for receiving a request for synchronizing a re-focusable photograph 131, configured to receive a request for synchronizing the re-focusable photograph sent from the first terminal device; an ID feedback module 132, configured to return an ID to the first terminal device, wherein the ID identifies the re-focusable photograph group to be synchronized; an uploaded data receiving module 133, configured to receive data for uploading the re-focusable photograph group uploaded from the first terminal device, wherein the data for uploading the re-focusable photograph group includes at least the ID, photograph data of each of the photographs in the re-focusable photograph group, intra-group numbers respectively corresponding to the photographs and an intra-group number corresponding to an index photograph in the re-focusable photograph group, and the intra-group number identifies a photograph in the re-focusable photograph group; and a photograph storing module 134, configured to store photograph data of each photograph and intra-group numbers corresponding to each photograph in the re-focusable photograph group according to the ID, and determine an index photograph in the re-focusable photograph group according to the intra-group number corresponding to the index photograph.

In the present disclosure, during the time a terminal device uploads the re-focusable photograph group to be synchronized to a binding server in a cloud, the server assigns the ID to the re-focusable photograph group, and the terminal device assigns the intra-group number to each photograph in the re-focusable photograph group. After the index photograph is determined, the intra-group number corresponding to the index photograph is informed to the server. Since the server learns about each intra-group number of each of the photograph in the re-focusable photograph group, in case where the index photograph of the re-focusable photograph group uploaded by the terminal device needs to be replaced subsequently, a replacement index photograph does not need to be re-uploaded, but only the intra-group number corresponding to the replacement index photograph and the corresponding ID need to be uploaded, thereby, network resources occupied by synchronizing the photograph may be saved.

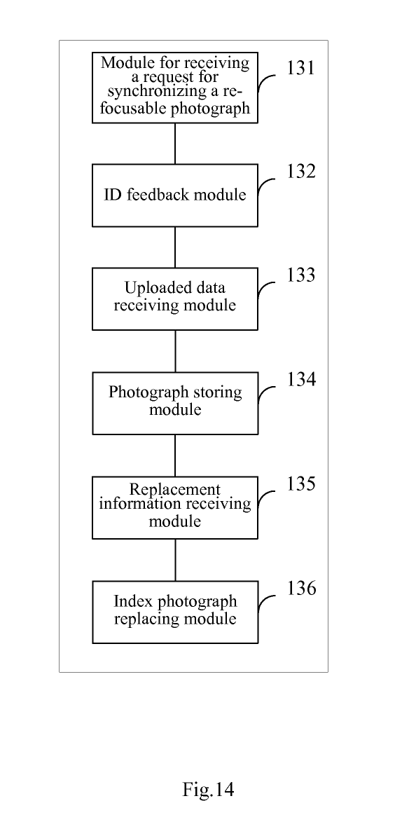

FIG. 14 shows another apparatus in a server according to another embodiment, and the server may further include: a replacement information receiving module 135, configured to receive information for replacing an index photograph uploaded from the first terminal device, wherein the information for replacing an index photograph includes an ID and an intra-group number corresponding to a replacement index photograph; and an index photograph replacing module 136, configured to replace the index photograph of the re-focusable photograph group identified by the ID, according to the ID and the intra-group number corresponding to the replacement index photograph.

In this embodiment, since the server learns about each intra-group number of each of the photographs in the re-focusable photograph group, in case where the index photograph of the re-focusable photograph group uploaded by the first terminal device needs to be replaced subsequently, the replacement index photograph does not need to be re-uploaded, but only the intra-group number corresponding to the replacement index photograph and the corresponding ID need to be uploaded, thereby, network resources occupied by synchronizing the photograph may be saved. Since the server learns about each intra-group number of each of the photographs in the re-focusable photograph group, upon receiving the intra-group number corresponding to the replacement index photograph and the corresponding ID uploaded by the first terminal device, the server may determine the replacement index photograph according to the intra-group number, and replace the index photograph.

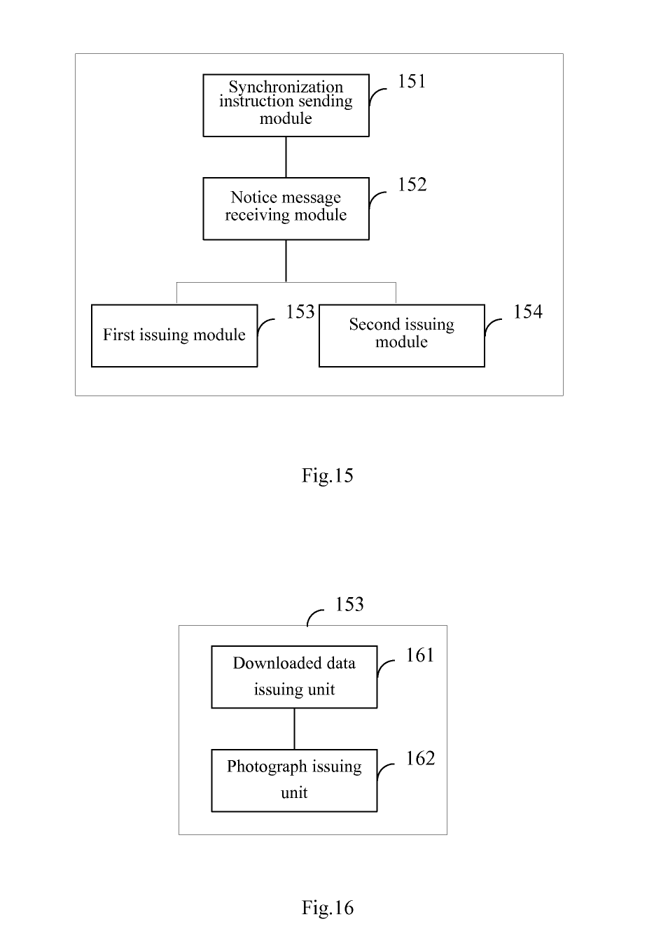

FIG. 15 shows another apparatus in a server for synchronizing a photograph downward according to an embodiment, and the apparatus may include: a synchronization instruction sending module 151, configured to send an instruction for synchronizing a re-focusable photograph to a second terminal device; a notification receiving module 152, configured to receive a notification returned from the second terminal device with regard to whether the second terminal device supports a display of re-focusable photographs; a first sending module 153, configured to send data for downloading the re-focusable photograph group to the second terminal device, if the second terminal device supports the display of the re-focusable photographs; and a second sending module 154, configured to send an index photograph of the re-focusable photograph group to the second terminal device, if the second terminal device does not support the display of the re-focusable photographs.

As shown in FIG. 16, in the apparatus of the server according to the embodiment, the first sending module 153 includes: a downloaded data sending unit 161, configured to send the data for downloading the re-focusable photograph group to the second terminal device, wherein the data for downloading the re-focusable photograph group include at least: an ID identifying the re-focusable photograph group to be sent, path information corresponding to storage path information of each photograph in the re-focusable photograph group, intra-group numbers indentifying each photograph respectively corresponding to the photographs in the re-focusable photograph group and an intra-group number identifying each photograph in the re-focusable photograph group corresponding to the index photograph in the re-focusable photograph group; and a photograph sending unit 162, configured to send each photograph in the re-focusable photograph group to the second terminal device, and set an index photograph of the re-focusable photograph group according to the intra-group number corresponding to the index photograph.

In the present disclosure, the photograph sending unit is configured to send the index photograph of the re-focusable photograph group to the second terminal device, according to the intra-group number corresponding to the index photograph of the re-focusable photograph group.

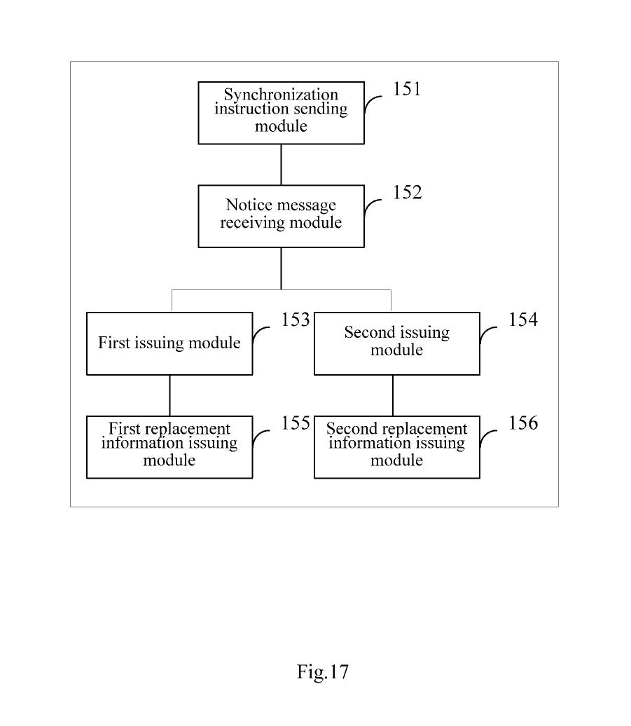

FIG. 17 shows another apparatus in a server according to an embodiment, and the server includes: a first replacement information sending module 155, configured to send information for replacing an index photograph to a second terminal device, wherein the second terminal device replaces the index photograph of the re-focusable photograph group, if the second terminal device supports a display of re-focusable photographs, and the information for replacing an index photograph includes an ID and an intra-group number corresponding to an replacement index photograph; and a second replacement information sending module 156, configured to send a replacement index photograph to the second terminal device to replace the index photograph of the re-focusable photograph group, if the second terminal device does not support the display of the re-focusable photographs.

In practical application, the index photograph sent to the second terminal device may be a thumbnail corresponding to the photograph or its photograph data. In addition, each of the photographs in the re-focusable photograph group sent to the second terminal device may be a thumbnail corresponding to the photograph respectively or its photograph data.

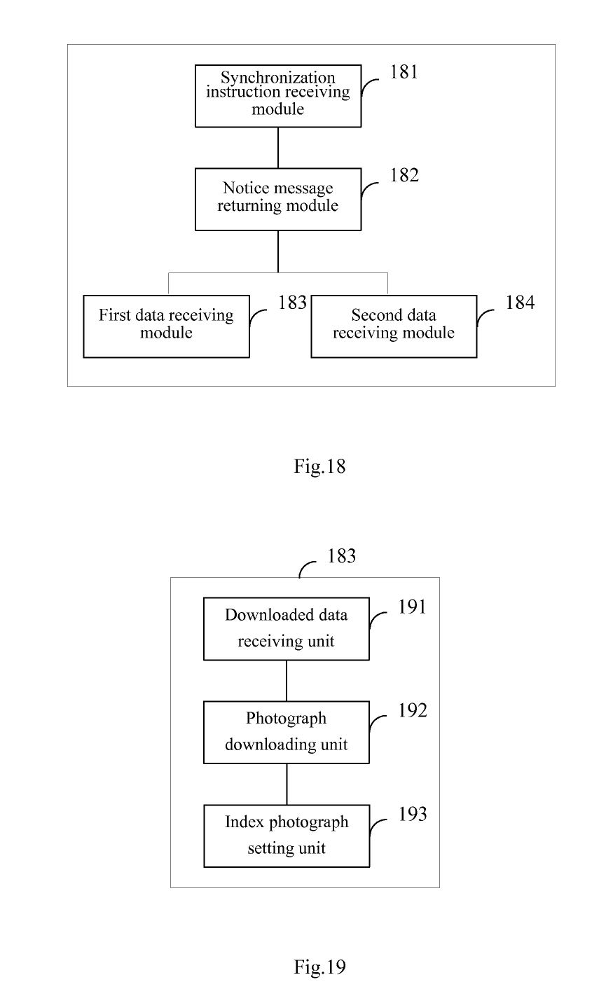

A block diagram showing an apparatus in a second terminal device according to an embodiment is also provided by the present disclosure accordingly. As shown in FIG. 18, the apparatus in the second terminal device according to an embodiment may include: a synchronization instruction receiving module 181, configured to receive an instruction for synchronizing a re-focusable photograph sent from a server; a notification returning module 182, configured to return a notification with regard to whether a display of re-focusable photographs is supported to the server; a first data receiving module 183, configured to receive data for downloading the re-focusable photograph group send from the server, if the display of the re-focusable photographs is supported; and a second data receiving module 184, configured to receive an index photograph of the re-focusable photograph group send from the server, if the display of the re-focusable photographs is not supported.

As shown in FIG. 19, in the apparatus in the second terminal device according to an embodiment, the first data receiving module 183 may include: a downloaded data receiving unit 191, configured to receive the data for downloading the re-focusable photograph group sent from the server, and the data for downloading the re-focusable photograph group include at least: an ID identifying the re-focusable photograph group to be sent, path information corresponding to storage path information of each photograph in the re-focusable photograph group, intra-group numbers indentifying each photograph respectively corresponding to the photographs in the re-focusable photograph group and an intra-group number identifying each photograph in the re-focusable photograph group corresponding to the index photograph in the re-focusable photograph group; a photograph downloading unit 192, configured to download each photograph in the re-focusable photograph group sent from the server according to the path information; and an index photograph setting unit 193, configured to set an index photograph of the re-focusable photograph group according to the intra-group number corresponding to the index photograph.

Wherein, the photograph downloading unit may be configured to download the index photograph of the re-focusable photograph group according to the intra-group number corresponding to the index photograph of the re-focusable photograph group.

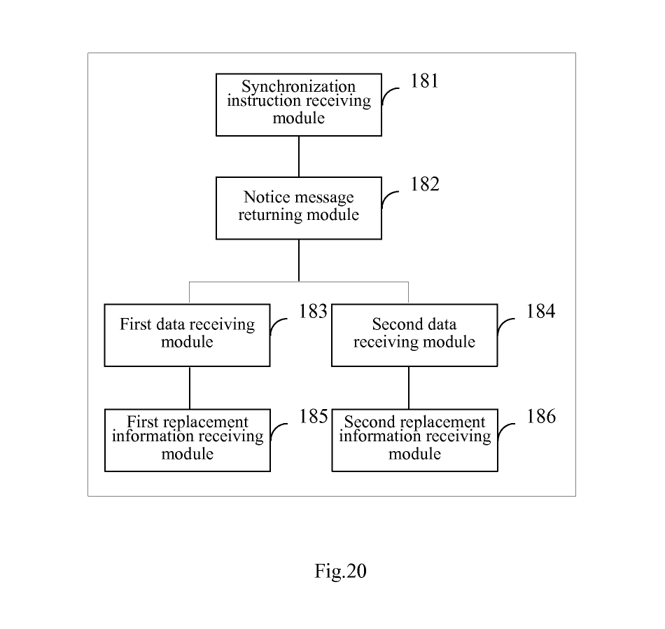

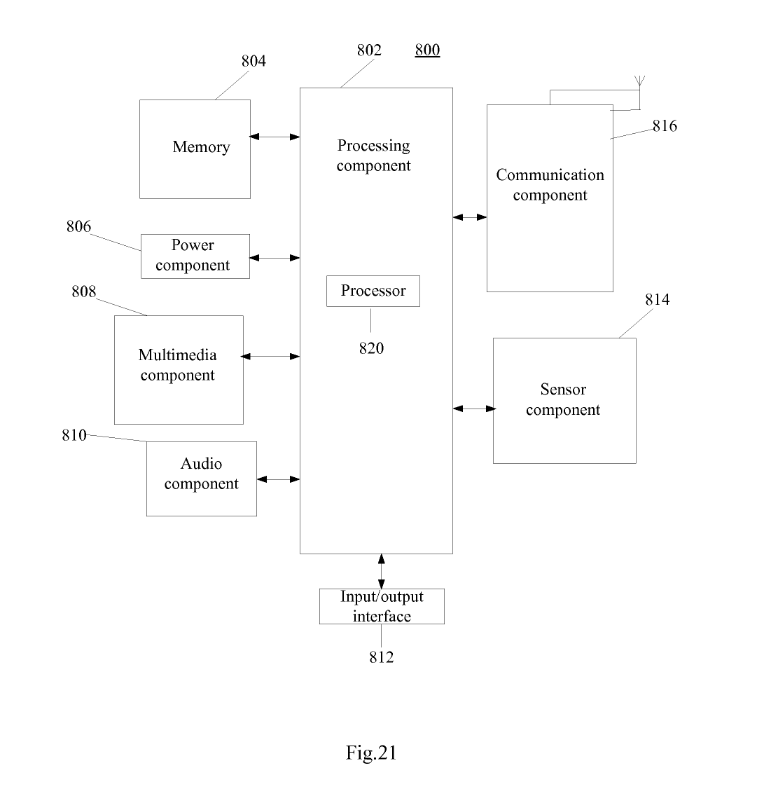

The apparatus in the second terminal device according to an embodiment shown in FIG. 20 may further include: a first replacement information receiving module 185, configured to receive information for replacing an index photograph sent from the server, if a display of re-focusable photographs is supported, wherein the information for replacing the index photograph includes: the ID and an intra-group number corresponding to a replacement index photograph, and the index photograph of the re-focusable photograph group identified by the ID is replaced according to the ID and the intra-group number corresponding to the replacement index photograph; and a second replacement information receiving module 186, configured to receive the replacement index photograph sent from the server, to replace the index photograph of the re-focusable photograph group, if the display of the re-focusable photographs is not supported.

In practical application, the index photograph sent by the server may be a thumbnail corresponding to the photograph or its photograph data. In addition, each of the photographs in the re-focusable photograph group sent by the server may be a thumbnail corresponding to the photograph respectively or its photograph data.

With respect to the terminal devices and servers in the above embodiments, the specific manners for performing operations for individual modules therein have been described in detail in the embodiments with regarding to the relative methods, which will not be elaborated herein. According to the present disclosure, the apparatuses in the terminal devices or servers may be implemented as hardware or software, such as a set of function modules, which constitutes as a part of the terminal devices or servers.

FIG. 21 is a block diagram showing a terminal device for synchronizing a photograph 800 according to an exemplary embodiment. For example, the device 800 may be a mobile phone, a computer, a digital broadcast terminal, a messaging device, a gaming console, a tablet, a medical device, exercise equipment, a personal digital assistant, and the like.

Referring to FIG. 21, the device 800 may include one or more of the following components: a processing component 802, a memory 804, a power component 806, a multimedia component 808, an audio component 810, an input/output (I/O) interface 812, a sensor component 814 and a communication component 816.

The processing component 802 typically controls overall operations of the device 800, such as the operations associated with display, telephone calls, data communications, camera operations and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the device 800. Examples of such data include instructions for any applications or methods operated on the device 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the device 800. The power component 806 may include a power management system, one or more power sources, and any other components associated with the generation, management, and distribution of power in the device 800.

The multimedia component 808 includes a screen providing an output interface between the device 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the device 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the device 800. For instance, the sensor component 814 may detect an open/closed status of the device 800, relative positioning of components, e.g., the display and the keypad, of the device 800, a change in position of the device 800 or a component of the device 800, a presence or absence of user contact with the device 800, an orientation or an acceleration/deceleration of the device 800, and a change in temperature of the device 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the device 800 and other devices. The device 800 can access a wireless network based on a communication standard, such as WiFi, 2G, or 3G, or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology and other technologies.

In exemplary embodiments, the device 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors or other electronic components, for performing the above described methods.

In exemplary embodiments, there is also provided a non-transitory computer-readable storage medium including instructions, such as included in the memory 804, executable by the processor 820 in the device 800, for performing the above-described methods. For example, the non-transitory computer-readable storage medium may be a ROM, a RAM, a CD-ROM, a magnetic tape, a floppy disc, an optical data storage device and the like.

A non-transitory computer readable storage medium, when instructions in the storage medium are executed by the processor of a server, causes the server to perform a method for synchronizing a photograph. The method includes: sending an instruction for synchronizing a re-focusable photograph to a second terminal device; receiving a notification returned from the second terminal device with regard to whether the second terminal device supports a display of re-focusable photographs; sending data for downloading a re-focusable photograph group to the second terminal device, if the second terminal device supports the display of the re-focusable photographs; and sending an index photograph of the re-focusable photograph group to the second terminal device, if the second terminal device does not support the display of the re-focusable photographs. Still another non-transitory computer readable storage medium, when instructions in the storage medium are executed by the processor of the terminal device, causes the terminal device to perform a method for synchronizing a photograph. The method includes: receiving an instruction for synchronizing a re-focusable photograph sent from a server; returning a notification with regard to whether the terminal device supports a display of re-focusable photographs; receiving data for downloading the re-focusable photograph group sent from the server, if the terminal device supports the display of the re-focusable photographs; and receiving an index photograph of the re-focusable photograph group sent from the server, if the terminal device does not support the display of the re-focusable photographs.

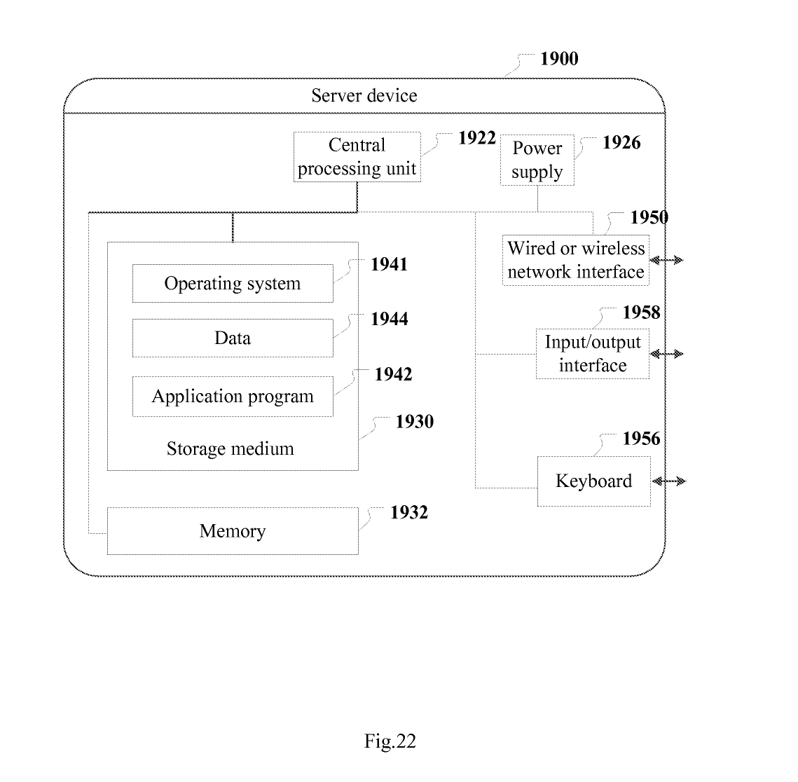

FIG. 22 is a block diagram showing a server according to an embodiment of the present disclosure. The server 1900 may vary in configuration or capabilities, and may include one or more central processing units (CPU) 1922 (for example, one or more processors), and a memory 1932, one or more storage media 1930 (for example, one or more mass storage devices) for storing application programs 1942 and data 1944. Wherein, the memory 1932 and the storage medium 1930 may be a transient or a persistent storage. The programs stored in the storage medium 1930 may include one or more modules (not shown in the Figures) each corresponding to a set of instructions in a terminal device. Further, the central processing unit 1922 is configured to communicate with the storage medium 1930 and execute the set of instructions in the storage medium 1930 on the server 1900.

The server 1900 may also include one or more power components 1926, one or more wired or wireless network interfaces 1950, and one or more input/output interfaces 1958, one or more keyboards 1956, and/or, one or more operating systems 1941, such as Windows Server™, Mac OS X™, Unix™, Linux™, FreeBSD™, and the like.

Other embodiments of the disclosure may be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It may be appreciated that the present disclosure is not limited to the exact construction that has been described above and illustrated in the accompanying drawings, and that various modifications and changes may be made without departing from the scope thereof. It is intended that the scope of the disclosure only be limited by the appended claims.

What is claimed is:

1. A method for synchronizing a photograph in a server, comprising:
sending an instruction for synchronizing a re-focusable photograph to a second terminal device;
receiving a notification returned from the second terminal device with regard to whether the second terminal device supports a display of re-focusable photographs;
sending data for downloading a re-focusable photograph group to the second terminal device, if the second terminal device supports the display of the re-focusable photographs; and
sending an index photograph of the re-focusable photograph group to the second terminal device, if the second terminal device does not support the display of the re-focusable photographs.

2. The method of claim 1, wherein sending the data for downloading the re-focusable photograph group to the second terminal device comprises:
sending the data for downloading the re-focusable photograph group to the second terminal device, wherein the data for downloading the re-focusable photograph group comprises at least an ID identifying the re-focusable photograph group to be sent, path information corresponding to storage path information of each photograph in the re-focusable photograph group, intra-group numbers indentifying each photograph respectively corresponding to the photographs in the re-focusable photograph group and an intra-group number identifying each photograph in the re-focusable photograph group corresponding to the index photograph in the re-focusable photograph group;
transmitting each photograph in the re-focusable photograph group to the second terminal device; and
setting an index photograph of the re-focusable photograph group according to the intra-group number corresponding to the index photograph.

3. The method of claim 2, wherein transmitting each photograph in the re-focusable photograph group to the second terminal device comprises:
sending first the index photograph of the re-focusable photograph group to the second terminal device, according to the intra-group number corresponding to the index photograph of the re-focusable photograph group.

4. The method of claim 2, wherein in case where the index photograph of the re-focusable photograph group is to be replaced, the method further comprises:
sending information for replacing an index photograph to the second terminal device if the second terminal device supports the display of the re-focusable photographs, and the second terminal device replaces the index photograph of the re-focusable photograph group, wherein the information for replacing the index photograph comprises the ID and an intra-group number corresponding to a replacement index photograph; and
sending the replacement index photograph for the re-focusable photograph group to the second terminal device to replace the index photograph of the re-focusable photograph, if the second terminal device does not support the display of the re-focusable photographs.

5. The method of claim 1, further comprising:
receiving a request for synchronizing the re-focusable photograph sent from a first terminal device;
returning an ID to the first terminal device, wherein the ID identifies the re-focusable photograph group to be synchronized;
receiving data for uploading the re-focusable photograph group from the first terminal device, wherein the data for uploading the re-focusable photograph group comprises at least the ID, photograph data of each of the photographs in the re-focusable photograph group, intra-group numbers identifying each photograph respectively corresponding to the photographs in the re-focusable photograph group and an intra-group number identifying each photograph in the re-focusable photograph group corresponding to an index photograph in the re-focusable photograph group;
storing the photograph data of each photograph and the intra-group numbers corresponding to each photograph respectively in the re-focusable photograph group according to the ID; and
determining an index photograph in the re-focusable photograph group according to the intra-group number corresponding to the index photograph.

6. The method of claim 5, further comprising:
receiving information for replacing an index photograph uploaded from the first terminal device, wherein the information for replacing the index photograph comprises the ID and an intra-group number corresponding to the replacement index photograph; and
replacing the index photograph of the re-focusable photograph group identified by the ID, according to the ID and the intra-group number corresponding to the replacement index photograph.

7. A method for synchronizing a photograph in a terminal device, comprising:
receiving an instruction for synchronizing a re-focusable photograph sent from a server;
returning a notification with regard to whether the terminal device supports a display of re-focusable photographs;
receiving data for downloading the re-focusable photograph group sent from the server, if the terminal device supports the display of the re-focusable photographs; and
receiving an index photograph of the re-focusable photograph group sent from the server, if the terminal device does not support the display of the re-focusable photographs.

8. The method of claim 7, wherein receiving the data for downloading the re-focusable photograph group sent from the server comprises:
receiving the data for downloading the re-focusable photograph group sent from the server, wherein the data for downloading the re-focusable photograph group comprises at least an ID identifying the re-focusable photograph group to be sent, path information corresponding to storage path information of each photograph in the re-focusable photograph group, intra-group numbers indentifying each photograph respectively corresponding to the photographs in the re-focusable photograph group and an intra-group number identifying each photograph in the re-focusable photograph group corresponding to the index photograph in the re-focusable photograph group;
downloading each photograph in the re-focusable photograph group sent from the server according to the path information; and
setting an index photograph of the re-focusable photograph group according to the intra-group number corresponding to the index photograph.

9. The method of claim 8, wherein downloading each photograph in the re-focusable photograph group sent from the server according to the path information comprises:
downloading the index photograph of the re-focusable photograph group according to the intra-group number corresponding to the index photograph of the re-focusable photograph group.

10. The method of claim 8, wherein in case where the index photograph of the re-focusable photograph group is to be replaced, the method further comprises:
receiving information for replacing an index photograph sent from the server, if the display of the re-focusable photographs is supported, wherein the information for replacing the index photograph comprises the ID and an intra-group number corresponding to a replacement index photograph;
replacing the index photograph of the re-focusable photograph group identified by the ID according to the ID and the intra-group number corresponding to the replacement index photograph; and
receiving the replacement index photograph sent from the server to replace the index photograph of the re-focusable photograph group, if the display of the re-focusable photographs is not supported.

11. A server synchronizing a photograph in a terminal device, comprising:
a processor; and
a memory for storing instructions executable by the processor,
wherein the processor is configured to perform:
sending an instruction for synchronizing a re-focusable photograph to a second terminal device;
receiving a notification returned from the second terminal device with regard to whether the second terminal device supports a display of re-focusable photographs;
sending data for downloading a re-focusable photograph group to the second terminal device, if the second terminal device supports the display of the re-focusable photographs; and
sending an index photograph of the re-focusable photograph group to the second terminal device, if the second terminal device does not support the display of the re-focusable photographs.

12. The server of claim 11, wherein sending the data for downloading the re-focusable photograph group to the second terminal device comprises:
sending the data for downloading the re-focusable photograph group to the second terminal device, wherein the data for downloading the re-focusable photograph group comprises at least an ID identifying the re-focusable photograph group to be sent, path information corresponding to storage path information of each photograph in the re-focusable photograph group, intra-group numbers indentifying each photograph respectively corresponding to the photographs in the re-focusable photograph group and an intra-group number identifying each photograph in the re-focusable photograph group corresponding to the index photograph in the re-focusable photograph group;
transmitting each photograph in the re-focusable photograph group to the second terminal device; and
setting an index photograph of the re-focusable photograph group according to the intra-group number corresponding to the index photograph.

13. The server of claim 12, wherein transmitting each photograph in the re-focusable photograph group to the second terminal device comprises:
sending first the index photograph of the re-focusable photograph group to the second terminal device according to the intra-group number corresponding to the index photograph of the re-focusable photograph group.

14. The server of claim 12, wherein in case where the index photograph of the re-focusable photograph group is to be replaced, the processor is further configured to perform:
sending information for replacing an index photograph to the second terminal device if the second terminal device supports the display of the re-focusable photographs, and the second terminal device replaces the index photograph of the re-focusable photograph group, wherein the information for replacing the index photograph comprises the ID and an intra-group number corresponding to a replacement index photograph; and
sending the replacement index photograph for the re-focusable photograph group to the second terminal device to replace the index photograph of the re-focusable photograph, if the second terminal device does not support the display of the re-focusable photographs.

15. The server of claim 11, wherein the processor is further configured to perform:
receiving a request for synchronizing the re-focusable photograph sent from a first terminal device;
returning an ID to the first terminal device, wherein the ID identifies the re-focusable photograph group to be synchronized;
receiving data for uploading the re-focusable photograph group from the first terminal device, wherein the data for uploading the re-focusable photograph group comprises at least the ID, photograph data of each of the photographs in the re-focusable photograph group, intra-group numbers identifying each photograph respectively corresponding to the photographs in the re-focusable photograph group and an intra-group number identifying each photograph in the re-focusable photograph group corresponding to an index photograph in the re-focusable photograph group;
storing the photograph data of each photograph and the intra-group numbers corresponding to each photograph respectively in the re-focusable photograph group according to the ID; and
determining an index photograph in the re-focusable photograph group according to the intra-group number corresponding to the index photograph.

16. The server of claim 15, wherein the processor is further configured to perform:
receiving information for replacing an index photograph uploaded from the first terminal device, wherein the information for replacing the index photograph comprises the ID and an intra-group number corresponding to the replacement index photograph; and
replacing the index photograph of the re-focusable photograph group identified by the ID, according to the ID and the intra-group number corresponding to the replacement index photograph.

17. A terminal device for synchronizing a photograph in a server, comprising:
a processor; and
a memory for storing instructions executable by the processor,
wherein the processor is configured to perform:
receiving an instruction for synchronizing a re-focusable photograph sent from a server;
returning a notification with regard to whether the terminal device supports a display of re-focusable photographs;
receiving data for downloading the re-focusable photograph group sent from the server, if the terminal device supports the display of the re-focusable photographs; and
receiving an index photograph of the re-focusable photograph group sent from the server, if the terminal device does not support the display of the re-focusable photographs.

18. The terminal device of claim 17, wherein receiving the data for downloading the re-focusable photograph group sent from the server comprises:
sending the data for downloading the re-focusable photograph group to the second terminal device, wherein the data for downloading the re-focusable photograph group comprises at least an ID identifying the re-focusable photograph group to be sent, path information corresponding to storage path information of each photograph in the re-focusable photograph group, intra-group numbers indentifying each photograph respectively corresponding to the photographs in the re-focusable photograph group and an intra-group number identifying each photograph in the re-focusable photograph group corresponding to the index photograph in the re-focusable photograph group;
transmitting each photograph in the re-focusable photograph group to the second terminal device; and
setting an index photograph of the re-focusable photograph group according to the intra-group number corresponding to the index photograph.

19. The terminal device of claim 18, wherein downloading each photograph in the re-focusable photograph group sent from the server according to the path information comprises:
downloading the index photograph of the re-focusable photograph group first, according to the intra-group number corresponding to the index photograph of the re-focusable photograph group.

20. The terminal device of claim 18, wherein in case where the index photograph of the re-focusable photograph group is to be replaced, the processor is further configured to perform:
receiving information for replacing an index photograph sent from the server, if the display of the re-focusable photographs is supported, wherein the information for replacing the index photograph comprises the ID and an intra-group number corresponding to a replacement index photograph;
replacing the index photograph of the re-focusable photograph group identified by the ID according to the ID and the intra-group number corresponding to the replacement index photograph; and
receiving the replacement index photograph sent from the server to replace the index photograph of the re-focusable photograph group, if the display of the re-focusable photographs is not supported.
